(19) United States
(12) Patent Application Publication
(10) Pub. No.: US 2020/0258285 A1
(43) Pub. Date: Aug. 13, 2020

(54) DISTRIBUTED COMPUTING SYSTEMS, GRAPHICAL USER INTERFACES, AND CONTROL LOGIC FOR DIGITAL IMAGE PROCESSING, VISUALIZATION AND MEASUREMENT DERIVATION

(71) Applicant: Chameleon Power, Inc., Novi, MI (US)

(72) Inventors: Daniel J. Dempsey, Northville, MI (US); William A. Westrick, Fort Wayne, IN (US); Wyatt T. Eurich, Canton, MI (US)

(73) Assignee: Chameleon Power, Inc., Novi, MI (US)

(21) Appl. No.: 16/784,587

(22) Filed: Feb. 7, 2020

Related U.S. Application Data
(60) Provisional application No. 62/803,043, filed on Feb. 8, 2019.

(51) Int. Cl. G06T 15/04; G06T 15/20; G06T 7/11

(52) U.S. Cl. CPC G06T 15/04; G06T 2207/30184; G06T 7/11; G06T 15/20

(57) ABSTRACT

Presented are computing systems and control logic for digital image processing with measurement derivation, devices for executing such logic, methods for operating such systems, and computer-readable media for carrying out such logic. A method of processing digital images generated by a user's image capture device includes a server computer receiving, over a distributed computing network from the user's image capture device, electronic files containing the digital images. The server computer processes the digital images for visualization, including converting each electronic file into a compatible image rendering language and mapping regions in the digital images for pattern replacement. The server computer adds query measurements to these mapped regions to determine measurements within multiple perspective planes based on image coordinates. These measurements and a modifiable rendered model of a target object in the digital images are generated using the query measurements for the mapped regions and displayed to the user.

### CLAIM OF PRIORITY AND CROSS-REFERENCE TO RELATED APPLICATION

This application claims the benefit of, and priority to, U.S. Provisional Patent Application No. 62/803,043, which was filed on Feb. 8, 2019, and is incorporated herein by reference in its entirety and for all purposes.

### TECHNICAL FIELD

The present disclosure relates generally to digital image processing systems. More specifically, aspects of this disclosure relate to computing systems, methods, and devices for digital image processing with object mapping and surface measurement.

### BACKGROUND

The real estate industry—including the residential, commercial, and industrial sectors of real estate—may be typified as the production, buying, selling, leasing, etc., of real property and the land to which it is affixed. In general, the residential real estate sector concentrates on the buying and selling of buildings and properties that are used for homes or for non-professional purposes. Comparatively, the commercial real estate sector is generally composed of non-residential properties used for business purposes, including retail and office space. Industrial real estate, on the other hand, includes buildings and properties used for manufacturing and production, such as warehouses, factories, plants, etc. A fourth sector within the real estate industry includes the buying and selling of undeveloped and vacant land, early development land, and abandoned structures intended for demolition or reuse.

As part of a real property construction or renovation project, a customer may be tasked with a myriad of selections, including structural aspects, such as floor plan, square footage, plumbing, electric, and HVAC hardware, as well as stylistic aspects, such as color schemes, fixtures, and materials. A general contractor or developer will use these selections as the primary basis for providing the customer with a quote for completing the desired project. Due to time and resource constraints, the contractor/developer may only provide the customer with a limited number of options for each category; oftentimes, the customer is not provided with a means to visualize available options. To help alleviate the burden of presenting and tracking such selections, recently developed software applications provision features for displaying various options associated with constructing/renovating real property and processing user selections from these options.

With continued improvements to computer processing, communication, and sensing capabilities, many entities now offer web tools and software applications for processing and manipulating digital images. For some commercially available “offline” applications, a user generates a digital image using an image capture device, such as a digital camera with a complementary metal-oxide-semiconductor (CMOS) or charge-coupled device (CCD) optical image sensor. An electronic file of the resultant image is imported into and manipulated via a software application operating on the user's personal computing device. By comparison, many distributed-computing “online” techniques provide end users with a web browser interface through which a digital image file is exported to a back-end, server-grade computer. Using the web browser interface, the end user may manipulate the imported image using, for example, Java applets or other similarly suitable platform applets. In both of the foregoing examples, the image-manipulation design tool may allow the user to crop the image, modify colors in the image, edit the background of the image, and otherwise create a customized product.

### SUMMARY

Disclosed herein are distributed computing systems with attendant control logic for digital image processing with surface mapping and measurement derivation services, integrated circuit (IC) devices for executing such control logic, methods for operating such systems, and processor-executable algorithms and computer-readable media provisioning such logic. In an example, there is presented a PHOTO+MEASURE® web engine that provides a digital image visualization service along with web tools for accurately determining measurements of objects present within the image. A user-supplied digital image has one or more designated surface areas that are interactively mapped to obtain a mapped image. In this way, the mapped image can be dynamically measured, modeled and altered online at a web site via a public communication network, such as the Internet. The dynamic measure component may derive accurate measurements of an imaged object, including surface length, width, area, angle, etc. For at least some implementations, the dynamic measure component adds measurements based on a proprietary perspective algorithm that may be used, for example, to calculate an amount of materials (e.g., roof shingles, home siding, etc.) to build or repair a house. Optional tools within the web engine allow users to modify their digital photos for visualization by selecting from one or more lists (e.g., roofing options, siding options, other interior and exterior features, etc.).

Aspects of this disclosure are directed to distributed computing systems, personal computing devices, and handheld portable cellular and wireless-enabled devices executing memory-stored instructions, web browsers with webpages, and/or dedicated mobile software applications (“apps”) for carrying out any of the disclosed features. In an example, a distributed computing system includes one or more electronic input devices that are configured to receive inputs from a user, one or more electronic display devices operable to display data to the user, and one or more communications devices configured to communicate, wired or wirelessly, with a remote database system over a distributed computing network. A server-class host computer with one or more processors is communicatively connected to the electronic input and display devices.

Continuing with the above example, the processor(s) is/are programmed to: receive, from an image capture device of the user over a distributed computing network, one or more electronic files containing multiple digital images of a desired structure or other target object; process the digital images for visualization, including converting the electronic file(s) into a compatible image rendering language and mapping multiple regions within the digital images for pattern replacement; add query measurements to the mapped regions of the processed digital images to determine measurements within multiple perspective planes based on dynamically generated image coordinates; generate a set of measurements for the desired structure present in the digital images using the query measurements for the mapped regions; and transmit, to the user via a personal computing device having an electronic display device, a report containing the set of measurements for the desired structure. This system architecture helps to streamline and expedite image modeling, rendering and visualization which, in turn, reduces system load and attendant latency while simplifying the user-interface and the data presented therein.

In another non-limiting example, there is presented an image mapping and modeling system for processing digital images generated by one or more image capture devices with one or more optical sensors. This system includes one or more resident or remote memory device storing therein processor-executable software components, including an image processing module, a pro-mapping service, a scaling and measuring service, and rendering and visualization engine. One or more wireless communications devices are operable to communicatively connect to an image capture device (e.g., a smartphone or tablet computer with digital camera) over a distributed computing network. A server computer, which may be composed of a network of computing devices, includes one or more processors that are connected to the resident memory device and the wireless communications device.

Continuing with the above example, the processor is programmed to receive multiple electronic data files from the image capture device—directly or through an intermediary device—containing multiple digital images with different perspectives of a target object. The server computer processor(s) execute the image processing module to process the digital images, which includes converting each data file to an application-compatible image rendering language, such as CFX. At least one processor executes the pro-mapping service to map multiple surface regions of the target object from the converted electronic data file. Each of these mapped surface regions is selectively modifiable with a replacement overlay. The scaling and measuring service is executed to add to the converted electronic data files query measurements as data points with respective image coordinates associated with the mapped surface regions. In addition, the scaling and measuring service is then executed to derive a set of measurements within multiple perspective planes for surfaces of the target object in the digital image using the query measurements for the mapped surface regions. Using this data, the rendering and visualization engine generates a modifiable 2D or 3D rendered model of the target object. The server computer then transmits the modifiable rendered model and a report containing the set of measurements to a user's personal computing device for visualization, real-time modification, etc.

Other aspects of the disclosure are directed to control logic, processor-executable, memory-stored computer readable media, and computer algorithms for provisioning any of the disclosed methods and techniques. In an example, a method is presented for processing one or more digital images generated by a digital image capture device of a user. This representative method includes, in any order and in any combination with any of the above and below disclosed options and features: receiving, via a server computer over a distributed computing network from the image capture device of the user, one or more electronic files containing the digital images; processing, via the server computer, each of the digital images for visualization including converting each electronic file into a compatible image rendering language and mapping one or more regions in each digital image for pattern replacement; adding, via the server computer, query measurements to the mapped regions of the processed digital images to determine measurements within multiple perspective planes based on image coordinates; generating, via the server computer, a set of measurements for a desired structure present in the digital images using the query measurements for the mapped regions; and displaying, to the user via an electronic display device, a report containing the set of measurements for the desired structure. The method may also include transmitting to the user prompts with instructions indicating specific angles and distances for the captured digital images. As another option, the method may include providing the user with a visualizer tool with a predetermined set of user-selectable options for modifying one or more of the digital images.

In another example, a method is presented for mapping and modeling objects present in digital images generated by image capture devices with optical sensors. This representative method includes, in any order and in any combination with any of the herein disclosed options and features: receiving, via a host computer from the image capture device, an electronic data file containing a digital image with a target object; processing, via an image processing module of the host computer, the digital image including converting the data file into an application-compatible image rendering language; mapping, via a pro-mapping service of the host computer, multiple surface regions of the target object in the digital image of the converted electronic data file, each of the mapped surface regions being selectively modifiable with a replacement overlay; adding, via a scaling and measuring service of the host computer, query measurements to the converted electronic data file, the query measurements being added as data points with respective image coordinates associated with the mapped surface regions; determining, via the scaling and measuring service, a set of measurements within multiple perspective planes for surfaces of the target object in the digital image using the query measurements for the mapped surface regions; and displaying, via a rendering and visualization engine on an electronic display device, the set of measurements and a modifiable rendered model of the target object.

For any of the disclosed systems, methods and devices, a received electronic data file may include multiple data files, each of which may contain one or more digital images with different perspective views of the target object. Converting an electronic data file into an application-compatible image rendering language may include associating each digital image with a respective CFX descriptor file. As another option, mapping the surface regions of a target object may include applying descriptor language syntax to its converted electronic data files to identify the surfaces of the target object within the multiple perspective planes. Each of these identified surfaces may be parsed into a respective set of perspective regions, with the perspective regions in a given set representing different perspective planes for that surface. CFX conversion functions as a transformation of the object images (i.e., a particular article) to an image-renderable format (i.e., a different state); image rendering functions to reduce the transformed object images into an adaptable model (i.e., a different thing).

For any of the disclosed systems, methods and devices, the perspective regions of the target object may be assigned perspective transformations that relate one or more respective image coordinates in the image to one or more respective texture coordinates, e.g., on a one-to-one basis with one image coordinate mapped to one texture coordinate. As yet a further option, the rendering and visualization engine, using these perspective transformations of the identified surfaces, may replace pixels within each of the perspective regions in an image space of the digital image with a respective segment of a user-selected pattern in a texture space of the pattern. For at least some implementations, each query measurement may include a length, area, perimeter, and/or slope associated with a respective one of the perspective regions. In this regard, determining a set of measurements may include transforming the data points of the query measurements via a perspective transform to the texture space within which 2-dimensional measurements are taken.

For any of the disclosed systems, methods and devices, the modifiable rendered model is a multi-dimensional (2D or 3D) rendering of the target object that is superimposed over the target object within the digital image (albeit not per se visible to the user during visualization and modification). As yet a further option, the host computer or user's personal computing device may receive one or more user inputs selecting a desired replacement overlay from a displayed set of available, user-selectable replacement overlays. When selected, an electronic display device displays, in real-time, the mapped surface regions of the multi-dimensional rendering of the target object modified with the selected replacement overlay. In instances where the modifiable rendered model is a 3D rendering of the target object, the mapped surface regions in multiple the perspective planes of the 3D rendering are automatically displayed, in real-time, modified with the selected replacement overlay (e.g., so the user may readily switch between different views without having to reapply a desired overlay in each view). In this regard, one or more user inputs may be received to selectively rotate the 3D rendering of the target object and thereby view the mapped surface regions in any one of the available perspective planes.

For any of the disclosed systems, methods and devices, one or more user inputs may be received from the user's personal computing device to selection, from within the digital images, which surface regions to map via the pro-mapping service. In the same vein, the user may be prompted to identify the target object or objects contained in a digital image they wish to be mapped and modeled. A target object may take on any logically relevant form, including a residential, commercial and/or industrial building structure. In this regard, the selectively modifiable surface regions may include any surface of a target object visible in at least one of the digital images, including roof surfaces, exterior facade walls, driveway surfaces, landscape surfaces, flooring surfaces, interior walls, ceiling surfaces, etc., of a building structure.

The above summary is not intended to represent every embodiment or every aspect of the present disclosure. Rather, the foregoing summary merely provides an exemplification of some of the novel concepts and features set forth herein. The above features and advantages, and other features and attendant advantages of this disclosure, will be readily apparent from the following detailed description of illustrated examples and representative modes for carrying out the present disclosure when taken in connection with the accompanying drawings and the appended claims. Moreover, this disclosure expressly includes any and all combinations and subcombinations of the elements and features presented above and below.

### BRIEF DESCRIPTION OF THE DRAWINGS

FIG. 1 is a schematic diagram illustrating a representative distributed computing system architecture for performing digital image processing with surface mapping, measurement derivation, and model rendering in accordance with aspects of the present disclosure.

FIG. 2 is a screenshot showing a representative graphical user interface (GUI) operating on an image capture device with an optical sensor for capturing a digital image containing a target object in accordance with aspects of the present disclosure.

FIG. 3 is screenshot showing a representative GUI for importing electronic data files from the image capture device of FIG. 2 containing digital images with different perspective views of the target object.

FIG. 4 is screenshot showing a representative GUI for viewing a surface measurement report and a multi-dimensional rendered model of the target object superimposed in the digital images input in FIG. 3.

FIG. 5 is screenshot showing a representative GUI for real-time visualization and modification of the target object's multi-dimensional rendered model with an assortment of available replacement overlays.

FIG. 6 is a flowchart illustrating a representative algorithm for performing digital image processing with surface mapping, measurement derivation, and model rendering, which may correspond to memory-stored instructions executed by control logic circuitry, programmable electronic control unit, or other computer-based device or network of devices in accord with aspects of the disclosed concepts

The present disclosure is amenable to various modifications and alternative forms, and some representative embodiments are shown by way of example in the drawings and will be described in detail herein. It should be understood, however, that the novel aspects of this disclosure are not limited to the particular forms illustrated in the above-enumerated drawings. Rather, the disclosure is to cover all modifications, equivalents, combinations, subcombinations, permutations, groupings, and alternatives falling within the scope of this disclosure as encompassed by the appended claims.

### DETAILED DESCRIPTION

This disclosure is susceptible of embodiment in many different forms. Representative embodiments of the disclosure are shown in the drawings and will herein be described in detail with the understanding that these embodiments are provided as an exemplification of the disclosed principles, not limitations of the broad aspects of the disclosure. To that extent, elements and limitations that are described, for example, in the Abstract, Technical Field, Background, Summary, and Detailed Description sections, but not explicitly set forth in the claims, should not be incorporated into the claims, singly or collectively, by implication, inference or otherwise. For purposes of the present detailed description, unless specifically disclaimed: the singular includes the plural and vice versa; the words “and” and “or” shall be both conjunctive and disjunctive; the words “any” and “all” shall both mean “any and all”; and the words “including,” “containing,” “comprising,” “having,” and the like, shall each mean “including without limitation.” Moreover, words of approximation, such as “about,” “almost,” “substantially,” “approximately,” “generally,” and the like, may be used herein in the sense of “at, near, or nearly at,” or “within 0-5% of,” or “within acceptable manufacturing tolerances,” or any logical combination thereof, for example.

Presented herein are distributed computing systems, personal computing devices, webpages, dedicated mobile software applications (“apps”), control logic, processor-executable software, and computer algorithms for performing digital image processing with surface mapping, measurement derivation and multi-dimensional model rendering services. In an example, a web engine is disclosed that combines a photographic visualization service along with an accurate surface area measurement service. The web engine prepares user-generated digital images for visualization by allowing the user to select desired modifications to the photo, such as roofing types and colors, siding types and colors, flooring types and colors, paint types and colors, and other exterior and interior materials. The measure component includes accurate surface area measurements (e.g., with a margin of error of 5% or less) that may be used, for example, to request and/or provide a quote for building or repairing a home or other structure.

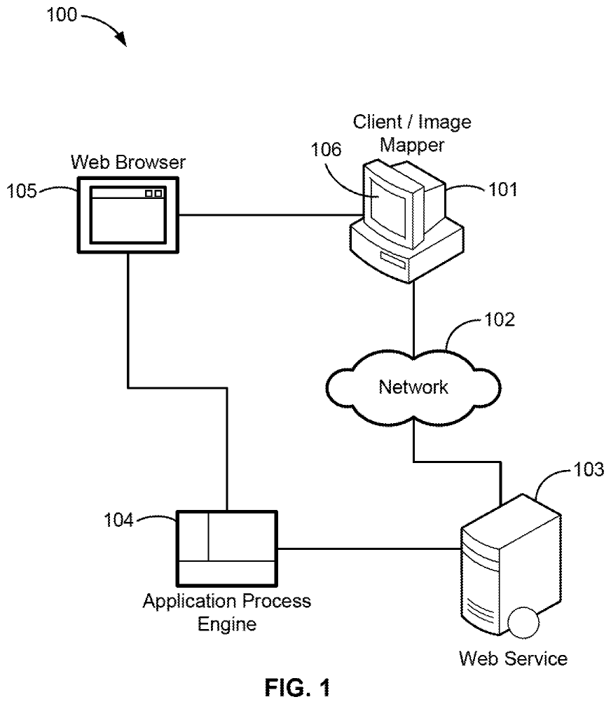

Referring now to the drawing figures, wherein like reference numbers refer to like features throughout the several views, there is shown illustrated in FIG. 1 a schematic diagram of a representative distributed computing system 100 operable for a user to perform electronic image processing and surface mapping with real-time measurement derivation. The illustrated computing system 100 is merely an exemplary application with which aspects and features of this disclosure may be practiced. In the same vein, implementation of the present concepts for home building and repair projects should also be appreciated as an exemplary application of the novel features disclosed herein. As such, it will be understood that aspects and features of this disclosure may be implemented through other distributed computing system architectures, carried out on any suitable integrated circuit (IC) device, and utilized for any logically relevant application.

Aspects of the present disclosure implement an “Image Mapper” software application for visualization and measurement of one or more objects in one or more digital images provided by one or more electronic files. In accordance with the representative distributed computing system 100 of FIG. 1, a Client/Image Mapper 101 includes a client computer programmed with Image Mapper software wherein, in general, the software maps points on a user-supplied image. For example, the Client/Image Mapper 101 enables a user to remotely perform a modification session on an electronic image wherein a user-supplied digital image contains a target object having one or more designated area to be modified is interactively mapped with a product to obtain, in real-time, a mapped image with the modified areas. In this way, the mapped image may be dynamically altered online at a web site via a public communication network, such as the Internet.

With continuing reference to FIG. 1, a Web Service 103 may be embodied as the host system implemented through a high-speed, server-grade computing device or a mainframe computer capable of handling bulk data processing, resource planning, and transaction processing. For instance, the Web Service 103 may operate as the host in a client-server interface for conducting any necessary data exchanges and communications with one or more “third party” servers to complete a particular transaction. Alternatively, the Web Service 103 may be implemented as a middleware node to provide different functions for dynamically onboarding heterogeneous devices, multiplexing data from each of these devices, and routing the data through reconfigurable processing logic for processing and transmission to one or more destination applications. A network 102 for communicatively connecting the Client/Image Mapper 101 to the Web Service 103 may be any available type of network, including a combination of public distributed computing networks (e.g., Internet) and secured private networks (e.g., local area network, wide area network, virtual private network). It may also include wireless and wireline transmission systems (e.g., satellite, cellular network, terrestrial networks, etc.). In at least some aspects, most if not all data transaction functions carried out by the Client/Image Mapper 101 may be conducted over a wireless network, such as a wireless local area network (WLAN), wireless metropolitan area network (WMAN), or cellular data network, to ensure freedom of movement of the user.

In accord with a non-limiting example, a user-generated digital image is sent in a data packet or other similarly suitable electronic file format from the Client/Image Mapper 101, over the Network 102, and to the Web Service 103. The Web Service 103 receives the user-supplied digital image, along with mapping data that is generated at the Client/Image Mapper 101. At the Web Service 103, the image and mapping data are processed so that an Application Process/Rendering Engine 104 can interpret the image and mapping data. A Web Browser 105 opened via an image mapper application operating on the Client/Image Mapper 101 directs the Web Browser 105 to the mapped image. An electronic display device 106 of the client computer present at the Client/Image Mapper 101 displays to the end user (client) a modified image where the user is provided with numerous options for changes surfaces of objects present in the mapped image.

As indicated above, the Web Browser 105 operating on the Client/Image Mapper 101 computing device and the Application Process Engine 104 executed via the Web Service 103 server-class computer cooperatively automate, among other things, the processing, mapping, measuring, modeling and visualization of target objects contained within photographic digital images. Control module, module, controller, control unit, electronic control unit, processor, engine, and any permutations thereof may be defined to include any one or various combinations of one or more of logic circuits, Application Specific Integrated Circuit(s) (ASIC), electronic circuit(s), central processing unit(s) (e.g., microprocessor(s)), input/output circuit(s) and devices, appropriate signal conditioning and buffer circuitry, and other components to provide the described functionality, etc. Associated memory and storage (e.g., read only, programmable read only, random access, hard drive, tangible, etc.)), whether resident, remote or a combination of both, store processor-executable software, firmware programs, modules, routines, etc.

Software, firmware, programs, instructions, routines, code, algorithms, and similar terms may be used interchangeably and synonymously to mean any processor-executable instruction sets, including calibrations and look-up tables. A system controller may be designed with a set of control routines and logic executed to provide the desired functions. Control routines are executed, such as by a central processing unit, and are operable to monitor inputs from sensing devices and other networked control modules, and execute control and diagnostic routines to control operation of devices and actuators. Routines may be executed in real-time, continuously, systematically, sporadically and/or at regular intervals, for example, each 100 microseconds, 3.125, 6.25, 12.5, 25 and 100 milliseconds, etc., during ongoing use or operation of the system 100.

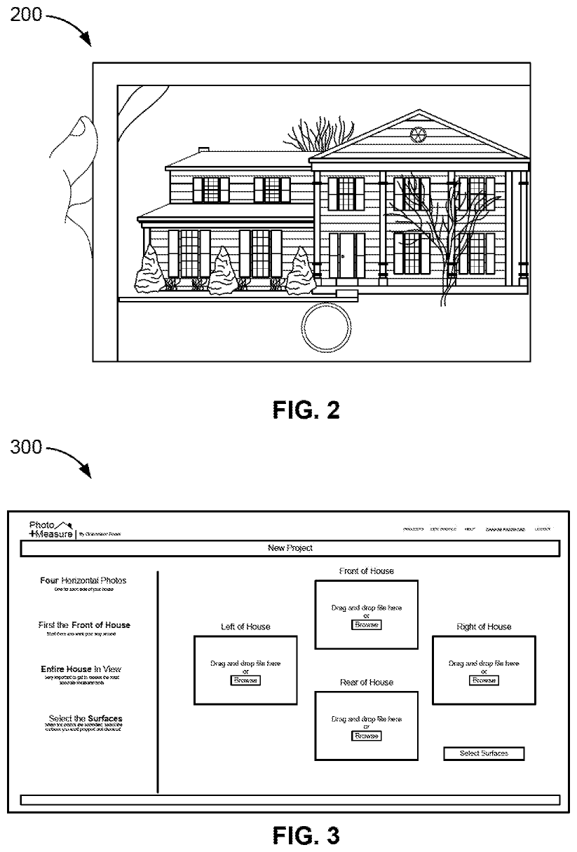

FIGS. 2-5 are screenshots of representative graphical user interfaces (GUI) that enable a user to perform digital image processing and visualization with surface mapping of an object captured within multiple digital images, and concomitantly execute image rendering and measurement services for modeling and deriving surface measurements of the object. FIG. 2, for example, illustrates an interactive Image Capture GUI 200 operating on a representative wireless-enabled handheld portable device, such as a tablet computer (as shown) or a digital camera or smartphone connected to desktop computer (e.g., client computer 101 of FIG. 1). Image Capture GUI 200 enables a user to take photos of multiple sides of a home, and upload electronic files of the digital images to an online PHOTO+MEASURE® web tool. Once all necessary views are captured as digital images, a web portal with an Image Import GUI 300 (e.g., presented by Web Browser 105 of FIG. 1) enables a user to drag-and-drop or upload the data files containing the digital images of the different perspective views of the object to the PHOTO+MEASURE® web tool (e.g., operating on Web Service 103 server computer).

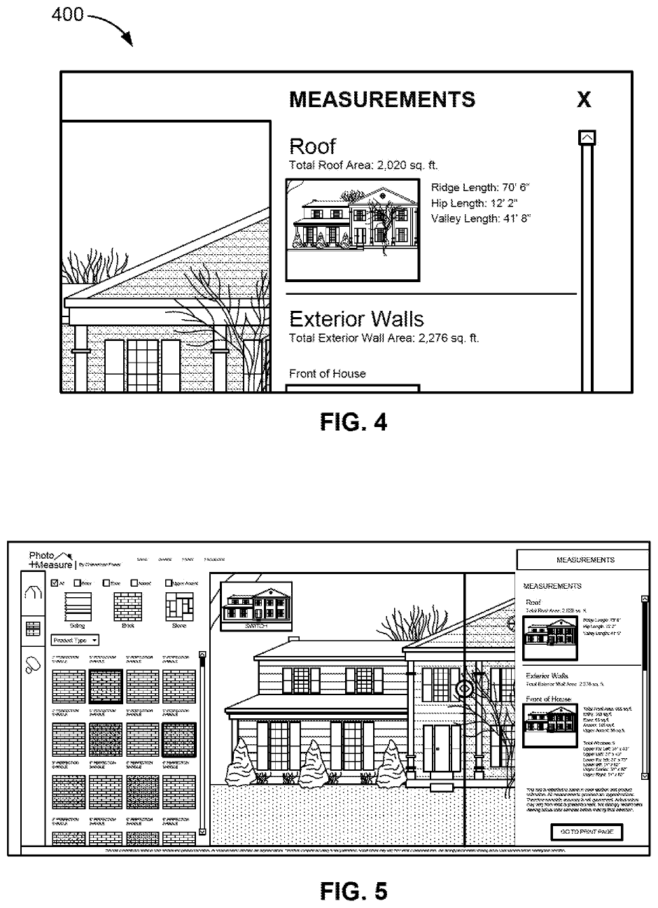

Turning next to FIG. 4, there is shown an interactive Dynamic Measure GUI 400 that enables a user to derive accurate measurements of one or more surface areas present in the captured digital images. These measurements may be displayed to an end user on their personal computing device and concomitantly offered as a downloadable measurement report. The user may use the Dynamic Measure GUI 400 to identify which surface or surfaces they wish to map and measure. An interactive Image Rendering and Visualization GUI 500 of FIG. 5 enables a user to display a modifiable, multi-dimensional rendered model of the target object. Image Rendering and Visualization GUI 500 enables the user to select and view color-accurate products superimposed on designated surface areas of the home captured in the digital photos.

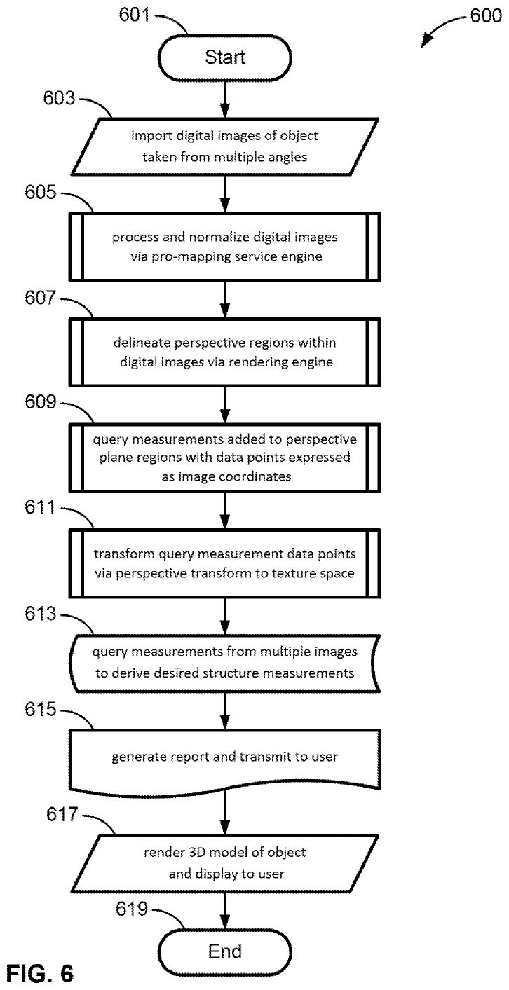

With reference now to the flowchart of FIG. 6, an improved method or control strategy for digital image processing with surface mapping and dynamic modeling and measurement derivation is generally described at 600 in accordance with aspects of the present disclosure. Some or all of the operations illustrated in FIG. 6 and described in further detail below may be representative of an algorithm that corresponds to processor-executable instructions that may be stored, for example, in main or auxiliary or remote memory, and executed, for example, by a resident or remote controller, processing unit, control logic circuit, or other module, device and/or network of devices, to perform any or all of the above or below described functions associated with the disclosed concepts. It should be recognized that the order of execution of the illustrated operation blocks may be changed, additional operations may be added, and some of the operation blocks described may be modified, combined, or eliminated.

Method 600 begins at terminal block 601 with processor-executable instructions for a programmable controller or control module or similarly suitable processor, server computer or network of devices to call up an initialization procedure for an automated digital image processing protocol with target object acquisition, mapping, measurement, and visualization. This routine may be executed in real-time, continuously, systematically, sporadically and/or at regular intervals. As yet another option, terminal block 601 may initialize responsive to a user command prompt or a broadcast prompt signal received from a backend or middleware computing node. As part of the initialization procedure at block 601, for example, a back-end server provisions a login screen to an end user through a web browser or network portal, e.g., with a prompt to enter personal identification information (e.g., an email and a password) or to create a new user account.

Terminal block 601 may further comprise outputting to the user an interactive help modal that explains, among other things, how to use any underlying web tools, and may present the meanings of various displayed modes and options to choose from a variety of selection states. While schematically illustrated as a “Web Browser” in FIG. 1, the operations provided by terminal block 601 and some or all of the operations subsequent thereto may be enabled through any other suitable software tool, including alternative File Transfer Protocol (FTP) standards, file hosting services (e.g., DROPBOX®), dedicated mobile software app, etc. As yet a further option, the user may be prompted to input project information describing the nature of the target object, the type of mapping and visualization that will be performed, and the measurements desired. It is also envisioned that process block 601 may be eliminated from method 600, e.g., in instances where the user is not required to sign in and/or protocol initialization is automated or continuous.

Method 600 of FIG. 6 advances from terminal block 601 to input/output block 603 with a user submitting multiple digital images of a desired structure or other target object taken from various different angles. By way of example, and not limitation, four or more photographic images capturing multiple predetermined aspects of a desired structure may be received and/or required. In accord with the residential property examples discussed herein (see FIG. 3), the user may be instructed to upload:
(1) a “Front of House” view (e.g., a generally horizontal one-point perspective view of the building's front facade including a front entrance door and/or structure closest to a corresponding street address roadway);
(2) a “Back of House” view (e.g., a generally horizontal one-point perspective view of the building's rear facade structure, opposite that of the front facade, including a patio/rear entrance door and/or structure farthest from to the roadway);
(3) a “Left of House” view (e.g., a generally horizontal two-point perspective view of the building's left-hand side—when viewed from the front—exterior facade structure extending between and adjoining the front and back of the house); and
(4) a “Right of House” view (e.g., a generally horizontal two-point perspective view of the building's right-hand side—when viewed from the front—exterior facade structure, opposite that of the left side, extending between and adjoining the front and back of the house).
   As would be appreciated by those skilled in the art, a horizontal perspective view is with respect to horizontal geodetic datum coordinate systems (i.e., parallel to the Earth's surface). For at least some implementation's, the interactive Image Capture GUI 200 may allow the user to simultaneously capture a digital image of a requisite view, preview the image for clarity and precision, then directly upload the image for processing. Image Import GUI 300 provides the user with guidance as to which views/angles are required (e.g., front, rear, left, right, perspective, etc.) and instructions detailing what features should or should not be captured in each view. Once uploaded, Dynamic Measure GUI 400 may prompt the user to select specific surfaces and/or regions of the target object they desire be mapped, measured, modeled, etc., for rendering and visualization.

Images may be exported from a personal computing device over a distributed computing network to a host server computer. In a specific, non-limiting implementation, the user utilizes a dedicated software application operating on a cellular smartphone or a wireless-enabled tablet computer, in conjunction with a high-definition (HD) digital camera integrated into the smartphone/tablet, to capture one or more of the requisite views. Alternatively, the user my utilize a web engine operating on a personal desktop or laptop computer to upload digital images from a resident memory device or a connected memory device (e.g., flash drive, subscriber identity module (SIM) card, etc.) to a host server computer. It is also envisioned that photos may be imported directly to the image-processing host computer (e.g., without the use of a distributed computing network) or image processing may be carried out by the same device that captured the images (e.g., via the app operating on the smartphone), or any combination of the above techniques.

With continuing reference to FIG. 6, subroutine process block 605 provides processor-executable instructions to process and normalize the digital images, including file conversion and region mapping, for image rendering and pattern replacement during visualization. By way of non-limiting example, the images may first be analyzed and prepared via a pro-mapping service. To do so, each image may be assigned a descriptor, such as a CFX file, that is associated with a compatible image rendering language. For instance, within the CFX framework, there is an “IMAGE=” parameter that associates the CFX with an image file (e.g., IMAGE=“myscene\house1.jpg”). It is expected that the web engine will likely interface with a myriad of heterogeneous device types, each of which may be equipped with a distinct optical sensor that inherently generates a distinct data file format containing images of a distinct quality. The CFX-conversion process helps to ameliorate this issue by associating the received data file with an application-compatible image rendering language. In so doing, the image data file can then be processed by a rendering engine to produce a visualization render.

A CFX file is not merely a file extension, but also an image modeling platform and an editing tool. CFX, as a file extension, is a descriptor language wherein the descriptor (CFX) language is an object based functional definition used to associate rendering configurations with image scenes (surfaces, perspectives, etc.) and to define texture patterns and behavior (repeats, patterns, scales, etc.) for various products. To render an image, a descriptor is formed by combining CFX files for the scene with various CFX files for the textures. Measurements may also be included in the CFX as described herein. In this case, the output of a captured seen within a digital image may include a quantification of the measurement queries. As an example, a converted image file—BillW1.cfx—is may be generated without measurement references; the file contains surface SRF definitions along with other parameters needed for rendering. By comparison, an extension file—BillW1m.cfx—may extend BillW1.cfx, adding the measurement queries to the original CFX conversion.

During the mapping process of subroutine process block 605, one or more regions in each digital image is mapped for pattern replacement. For instance, each mapped surface region may be selectively modified with a replacement overlay. Mapping a surface region of a target object may include applying descriptor language syntax to the CFX-converted file to identify surfaces within the captured digital images. As a non-limiting example, within the CFX framework, there is a “SURFACE=” parameter that contains a predefined list of “SRF( )” definitions for each surface in a given image. Each SRF may contain a “REGION=” parameter that references an image file that is the mask for the region or a list of “RGN( )” definitions that designate points of a polygon to define the region. This mask is part of the final model rendering that allows the target object's surfaces to be selectively modified in real-time. For at least some implementations, a surface region may be a predesignated region of the image that will be replaced by other patterns or colors in the rendering process, server-selected regions chosen through machine learning or system calibration, or regions selected by the user through a suitable GUI software tool, or any combination thereof.

Moving from subroutine 605 to subroutine process block 607, the method 600 of FIG. 6 breaks down the mapped surface regions into perspective regions. In particular, each surface region is parsed into a respective set of perspective regions. The perspectives regions of a given set are subregions of a surface that all lay on a common plane. Each perspective region may then be given a perspective transformation which relates an image coordinate of that perspective in the image to a texture coordinate in texture space. These transformations are used during the render process to replace pixels within a surface region in image space with a particular pattern in texture space. By way of non-limiting example, each SRF( ) definition may contain a “PERSPECTIVE=” definition that is drawn from a list of “PERSP( )” definitions. Like the SRF definitions described above, the PERSP( ) definitions may contain a REGION parameter that is a mask or polygon to subdivide the surface into a designated region within which is applied a specific perspective transform. The PERSP( ) definition may contain DEF=, ANCHOR= and DIM= parameters. Together, these parameters may help to define the perspective transformation. The “DEF=” parameter is a list of four ordered points in image space that define the four corners of a rectangle in texture space. Moreover, the “ANCHOR=” is a point in screen space that defines where on the image 0,0 appears in texture space. Lastly, the “DIM=” parameter is the X and Y length of the texture space rectangle. From these, a linear transformation matrix T is established to map image space to texture space.

Method 600 of FIG. 6 continues to subroutine process block 609, which provides processor-executable instructions to add query measurements to perspective maps in order to derive measurements within the computer-generated perspective planes based on the aforesaid image coordinates. These query measurements may be added as data points with respective image coordinates associated with the mapped surface regions. By way of example, and not limitation, query measurements are added to the converted CFX data file; there are several types of query measurements that can be added, including area, length, perimeter, slope, etc. Each measurement may be specific to a corresponding one of the perspective transforms described above. Data points for the measurements may be expressed in the image coordinates. In each case, the points in image space are transformed to texture space from which a real-world measurement can be taken. The specific transform used may include one the maps the SURFACE and then the PERSPECTIVE points given in the PLANE( ) definition in the MAESURE=list.

After image processing and normalization at block 605, perspective region construction and transformation at block 607, and query measurement addition and association at block 609, method 600 continues to subroutine process block 611 to transform the query measurement data points via perspective transform to texture space. Query measurements data points may be transformed via the perspective transform to texture space; this is where real-world, two-dimensional (2D) measurements are ascertained. During rendering, the render engine evaluates all of the query measurements and, from these queries, derives real-world surface areas, lengths, slopes, etc., for each designated surface of the desired structure. A special type of measurement, called a SET measurement, can also be added to the CFX descriptor file for the image. A SET measurement calibrates the perspective transform and helps to correct for errors in scale. In this way, known reference dimensions can be used to ensure dimensional accuracy. Image space points may be converted to texture points by transforming them through the perspective transform matrix T such that Q=PT, where P is a vector P=(px,py,1); and px and py are the x and y coordinates in image space. After calculating Q, which is a vector Q=(qx,qy,qz), the texture space coordinates can be determined as tx=qx/qz and ty=qy/qz. Transformed query measurement data points may be stored in cache memory for subsequent retrieval for surface measurement and model rendering.

Stored-data process block 613 includes recalling query measurements for the perspective plane surface regions from the various digital images to generate a report with the derived measurements for the desired structure. In at least some implementations, a set of query measurements may be limited to a single plane (perspectives) within a single image; these query measurements help to directly measure what is readily visible in a captured image. Query measurements from multiple images can be used to derive other desired measurements, such as the overall square footage of a building's foundation, total surface area for siding, total surface area for reroofing, etc. Some dimensions may be inferred, such as roof area from an edge that can be seen from several of the digital images.

Method 600 continues to document process block 615 to generate and transmit to a user a report with the desired structure measurements. In at least some representative implementations, an electronic notification (e.g., email, text, popup window, etc.) is transmitted to the user notifying them that their request has been processed, and they can access a report with desired measurement information through their user account. In this regard, a user account page may provide an order history, individual project information, project status, and links to view the report and to view the 2D or 3D model of the target object inlayed within the original image for desired visualization. For some implementations, deriving accurate measurements only requires four phots (e.g., as compared to eight (8) for other services) to simplify and expedite the process for the user.

Beyond automating derivation of accurate structural measurements of an imaged object, the digital images can also be used for photo-realistic visualization through multi-dimensional image rendering. At input/output block 619, for example, a renderable asset of a target objected contained in a collection of digital images is transferred to a suitable rendering and visualization engine to allow instantaneous manipulation via the user. This visualizer may enable real-time image editing, applying materials, textures, colors, and/or patterns to specific areas of interest, etc. Accompanying this renderable asset is any combination of the disclosed data accumulated above, including characteristic information of the roof structure, real property structure, surrounding area, and/or other target objects or target features in the image. Optional configurations may omit transmitting a renderable asset and, rather, send an electronic report containing a select set of data. Image rendering, as used herein, may be typified as a computer-automated process of generating a photorealistic image from a 2D or 3D model or models, in what collectively may be called a “scene file”, and vice versa.

Synthesizing the digital images to generate a multi-dimensional render of the desired structure may comprise rendering all available object perspectives from the original photographs with a grid pattern (e.g., polygonal lattice structure) on all visible surfaces. Adjustments may be made, as needed, to the visible perspective lines and image scale to ensure all needed perspectives coalesce in a cohesive manner, and that the perspective lines properly follow the object's real-world geometry. For a building's roof structure, the interconnected edges and roof creases are designated to identify an outer perimeter and other basic shapes as seen from the digital images. For siding, window frames and other openings and gaps in the exterior facade are identified, mapped, and measured; the geometric areas of these openings/gaps may be subtracted from a total surface area of the larger wall structure. Symmetries between imaged objects and object segments may be identified and used to infer measurements that may be more difficult to derive from a given set of images. For instance, a predefined set of target object features, such as doors, light fixtures, shutters garages/garage doors, siding slats and brick, and heating, ventilation and air conditioning (HVAC) units, etc., that come in known sizes, may be referenced for purposes of scale (e.g., to correct perspective to the right scale).

Derived surface measurements, as described hereinabove, are retrieved from the corresponding CFX files and added for a subject object during rendering. Prior to being added, these measurements may be tested against baseline specimens and compared to known measurements of similar structures, if available. As yet a further option, SET measurements may be added to correct scales where needed and available. By correcting measurements in the foregoing manner, other structural measurements may be derived or made more precise. From the user-provided digital images, a plan-view layout of the house is generated, which provides a basic footprint of the subject target object. By determining the area as viewed from above, and determining the slope of each section of the roof, the individual and total roof surface areas may be derived. A wire-frame is superposed over the outer surfaces of the target object's perimeter. The individual cells in the lattice structure that defines the wire frame may be modified to accommodate variances in depth and angle within each image.

During image rendering and visualization at input/output block 619, a user may be enabled to choose surfaces and product groups to map to these chosen surfaces on the user-supplied digital images, e.g., utilizing the client computer 101 programmed with the Image Mapper. The user may choose products directly on a web portal supported by the Web Service 103 over the network 102. Once chosen, the application process/rendering engine 104 renders selected products, in real-time, on the user's mapped and modeled image. A set of user-selected perspective points, wherein the user clicks different perspective points on a digital image, outlines a perspective area requested for visualization. This “perspective box” helps to control the angle and shape of new products (e.g., floorings for interior surfaces, roof shingles for exterior surfaces, etc.) to go into a particular region. Tools may be provisioned to draw and edit the shape of the box.

As seen in FIG. 5, the user may be provided with the option to juxtapose and view “before” and “after” views of a target object to perform a side-by-side comparison of the pre-modified and post-modified target object using a slide-bar. As yet a further option, user choices may be automatically carried over into the remaining views of the target object. For instance, after applying a selected brand and color of an exterior siding product to the front view of the house, the same selected brand and color is applied to the remaining exterior surfaces of the building structure's exterior facade in the left, right and back views of the object. Upon selection of a desired product, the web engine can automatically derive a total square footage of the selected product needed to renovate the selected exterior surfaces of the house, as well as provide an estimated cost for the products, and auto-generate an order of the product. A list of measurements and applied products can be saved to resident cache memory for subsequent retrieval. Each report may list all products that were viewed with a corresponding swatch thumbnail inset image of the house with the product, the corresponding estimated pricing, etc. The method 600 of FIG. 6 may thereafter advance from input/output block 617 to terminal block 619 and terminate, or may loop back to terminal block 601 and run in a continuous loop.

As is readily apparent to persons skilled in the art, the above control operations are not mere commonplace method steps aimed solely at processing and/or disseminating information, do not propose to apply a previously known process to the particular technological environment of computers or the Internet, and do not merely create or alter contractual or other business relations using generic computer functions and conventional network operations. Rather, disclosed features are directed to a specific implementation (e.g., automated image object measurement derivation and 2D/3D model rendering for instantaneous image visualization) of a solution (e.g., automated target object identification, mapping, and surface recognition) to a problem in the software arts (e.g., reducing processing burden and attendant latency times associated with existing web tools, improving image visualization and rendering for “life like” end results, and eliminating human-borne error associated with manual measurements and calculations). Many of the control operations illustrated, described and claimed herein cannot be carried out as a mental process by pad and pen, including digital image processing and normalization, file adaption through image rendering language conversion, surface identification through descriptor language syntax, perspective region transformation, query measurement data point expression and transformation, real-time model rendering and visualization, etc.

Disclosed features provide a specific process for automatically processing, analyzing and converting a digital image using particular digital-image-extracted information and conversion techniques, without preempting other existing and hereafter developed approaches. Since many of the control operations illustrated, described and claimed herein are novel, and not mere implementations of previously applied techniques on a computer system, other are not forestalled from utilizing those known and conventional techniques. When looked at as a whole, these features are technological improvements over existing, manual image processing techniques to achieve improved image mapping, measuring, and manipulation results. Disclosed features do not merely implement a mathematical algorithm in an abstract manner, but rather describe systems and methods that use optical sensing devices in a non-conventional manner to reduce errors in deriving measurements of aspects of an imaged object. In this regard, improved graphical user interfaces for integrated circuit devices are presented that encompass a particular manner of summarizing, visualizing, and manipulating image data that help to ameliorate problems with image management and switching views and also help to improve device efficiency by its organization of information.

Aspects of this disclosure may be implemented, in some embodiments, through a computer-executable program of instructions, such as program modules, generally referred to as software applications or application programs executed by any of a controller or the controller variations described herein. Software may include, in non-limiting examples, routines, programs, objects, components, and data structures that perform particular tasks or implement particular data types. The software may form an interface to allow a computer to react according to a source of input. The software may also cooperate with other code segments to initiate a variety of tasks in response to data received in conjunction with the source of the received data. The software may be stored on any of a variety of memory media, such as CD-ROM, magnetic disk, bubble memory, and semiconductor memory (e.g., various types of RAM or ROM).

Moreover, aspects of the present disclosure may be practiced with a variety of computer-system and computer-network configurations, including multiprocessor systems, microprocessor-based or programmable-consumer electronics, minicomputers, mainframe computers, and the like. In addition, aspects of the present disclosure may be practiced in distributed-computing environments where tasks are performed by resident and remote-processing devices that are linked through a communications network. In a distributed-computing environment, program modules may be located in both local and remote computer-storage media including memory storage devices. Aspects of the present disclosure may therefore be implemented in connection with various hardware, software or a combination thereof, in a computer system or other processing system.

Any of the methods described herein may include machine readable instructions for execution by: (a) a processor, (b) a controller, and/or (c) any other suitable processing device. Any algorithm, software, control logic, protocol or method disclosed herein may be embodied as software stored on a tangible medium such as, for example, a flash memory, a CD-ROM, a floppy disk, a hard drive, a digital versatile disk (DVD), or other memory devices. The entire algorithm, control logic, protocol, or method, and/or parts thereof, may alternatively be executed by a device other than a controller and/or embodied in firmware or dedicated hardware in an available manner (e.g., implemented by an application specific integrated circuit (ASIC), a programmable logic device (PLD), a field programmable logic device (FPLD), discrete logic, etc.). Further, although specific algorithms are described with reference to flowcharts depicted herein, many other methods for implementing the example machine-readable instructions may alternatively be used.

Aspects of the present disclosure have been described in detail with reference to the illustrated embodiments; those skilled in the art will recognize, however, that many modifications may be made thereto without departing from the scope of the present disclosure. The present disclosure is not limited to the precise construction and compositions disclosed herein; any and all modifications, changes, and variations apparent from the foregoing descriptions are within the scope of the disclosure as defined by the appended claims. Moreover, the present concepts expressly include any and all combinations and subcombinations of the preceding elements and features.

What is claimed:

1. A method of mapping and modeling objects in digital images generated by an image capture device with an optical sensor, the method comprising:
receiving, via a host computer from the image capture device, an electronic data file containing a digital image with a target object;
transforming, via an image processing module of the host computer, the digital image including converting the electronic data file to an application-compatible image rendering language;
mapping, via a pro-mapping service of the host computer, multiple surface regions of the target object in the digital image of the converted electronic data file, each of the mapped surface regions being selectively modifiable with a replacement overlay;
adding, via a scaling and measuring service of the host computer, query measurements to the converted electronic data file, the query measurements being added as data points with respective image coordinates associated with the mapped surface regions;
determining, via the scaling and measuring service, a set of measurements within multiple perspective planes for surfaces of the target object in the digital image using the query measurements for the mapped surface regions; and
displaying, via a rendering and visualization engine on an electronic display device, the set of measurements and a modifiable rendered model of the target object.

2. The method of claim 1, wherein the received electronic data file includes multiple data files containing multiple digital images with different perspective views of the target object, and wherein converting the electronic data file into the compatible image rendering language includes associating each of the digital images with a respective CFX descriptor file.

3. The method of claim 1, wherein mapping the multiple surface regions of the target object includes applying descriptor language syntax to the converted electronic data file to identify the surfaces of the target object within the multiple perspective planes.

4. The method of claim 1, further comprising parsing each of the identified surfaces into a respective set of perspective regions, the perspective regions in the respective set laying in a common one of the multiple perspective planes.

5. The method of claim 4, further comprising assigning each of the perspective regions a respective perspective transformation relating a respective image coordinate to a respective texture coordinate.

6. The method of claim 5, further comprising replacing, via the rendering and visualization engine using the respective perspective transformations of the identified surfaces, pixels within each of the perspective regions in an image space with a respective segment of a user-selected pattern in a texture space.

7. The method of claim 6, wherein each of the query measurements includes an area, a length, a perimeter, and/or a slope associated with a respective one of the perspective regions.

8. The method of claim 7, wherein determining the set of measurements includes transforming the data points of the query measurements via a perspective transform to the texture space within which 2-dimensional measurements are taken.

9. The method of claim 1, wherein the modifiable rendered model includes a multi-dimensional rendering of the target object superimposed over the target object within the digital image.

10. The method of claim 9, further comprising:
receiving, from a personal computing device of a user, a user selection of the replacement overlay from a displayed plurality of user-selectable replacement overlays; and
displaying, in real-time on the electronic display device, the mapped surface regions of the multi-dimensional rendering of the target object modified with the selected replacement overlay.

11. The method of claim 10, wherein the modifiable rendered model is a three-dimensional rendering of the target object, and wherein the mapped surface regions in three or more of the perspective planes of the three-dimensional rendering are displayed in real-time modified with the selected replacement overlay.

12. The method of claim 11, further comprising receiving, from a personal computing device of a user, a user selection to rotate the three-dimensional rendering of the target object and view the mapped surface regions in a selected one of the perspective planes.

13. The method of claim 1, further comprising receiving, from a personal computing device of a user, one or more user selections of one or more of the surface regions to be mapped via the pro-mapping service.

14. The method of claim 1, wherein the target object is a residential, commercial or industrial building structure, and wherein the surface regions include roof surfaces, flooring surfaces, exterior facade walls, interior walls, and/or ceiling surfaces of the building structure.

15. An image mapping and modeling system for processing digital images generated by an image capture device with an optical sensor, the system comprising:
a memory device storing therein an image processing module, a pro-mapping service, a scaling and measuring service, and rendering and visualization engine;
a wireless communications device operable to communicatively connect to the image capture device over a distributed computing network; and
a server computer with a processor connected to the memory device and the wireless communications device, the processor being programmed to:
receive multiple electronic data files from the image capture device containing multiple digital images with different perspectives of a target object;
transform the digital images including converting each of the electronic data files to an application-compatible image rendering language;
map multiple surface regions of the target object of the converted electronic data file, each of the mapped surface regions being selectively modifiable with a replacement overlay;
add query measurements as data points with respective image coordinates associated with the mapped surface regions;
determine a set of measurements within multiple perspective planes for surfaces of the target object in the digital image using the query measurements for the mapped surface regions;
generate a modifiable rendered model of the target object; and
transmit, to a personal computing device having an electronic display device, the modifiable rendered model and a report containing the set of measurements.

16. The system of claim 15, wherein converting the electronic data files into the compatible image rendering language includes associating each of the digital images with a respective CFX descriptor file.

17. The system of claim 15, wherein mapping the multiple surface regions of the target object includes applying descriptor language syntax to the converted electronic data file to identify the surfaces of the target object within the multiple perspective planes.

18. The system of claim 15, wherein the processor is further programmed to parse each of the identified surfaces into a respective set of perspective regions, each of the perspective regions in the respective set laying in a common one of the multiple perspective planes.

19. The system of claim 18, wherein the processor is further programmed to:
assign each of the perspective regions a respective perspective transformation relating a respective image coordinate to a respective texture coordinate; and
replace, using the respective perspective transformations of the identified surfaces, pixels within each of the perspective regions in an image space with a respective segment of a user-selected pattern in a texture space.

20. The system of claim 15, wherein the modifiable rendered model includes a multi-dimensional rendering of the target object superimposed over the target object displayed in the digital image, and wherein the processor is further programmed to:
receive, from the personal computing device of the user, a user selection of the replacement overlay from a displayed plurality of user-selectable replacement overlays; and
command the electronic display device to display, in real-time, the mapped surface regions of the multi-dimensional rendering of the target object modified with the selected replacement overlay.
